(19) United States
(12) Patent Application Publication
(10) Pub. No.: US 2026/0150137 A1
(43) Pub. Date: May 28, 2026

(54) System and Method for Managing Peer-to-Peer Group Communications

(71) Applicant: Zebra Technologies Corporation, Lincolnshire, IL (US)

(72) Inventors: Ohad Shatil, Dunwoody, GA (US); Sandeep Ramakrishnan, Bangalore (IN); Darpan Majumder, Bangalore (IN); Subramani Rajendiran, Bangalore (IN); Venkata Aneel Kumar Inuganti, Bangalore (IN); Naga Babu Parsi, Bangalore (IN); Satyendra Bhaisare, Woodside, NY (US); Mahesh Kumar Edar, Davenagere (IN)

(73) Assignee: Zebra Technologies Corporation, Lincolnshire, IL (US)

(21) Appl. No.: 19/288,713

(22) Filed: Aug. 1, 2025

Related U.S. Application Data
(60) Provisional application No. 63/724,473, filed on Nov. 25, 2024.

(51) Int. Cl. H04W 76/14; H04W 4/08; H04W 84/20

(52) U.S. Cl. CPC H04W 76/14; H04W 4/08; H04W 84/20

(57) ABSTRACT

An example method in a group of communication devices communicating via a peer-to-peer group communication session includes: designating an initial communication device in the group as a current group owner; maintaining an ordered list of the communication devices in the group based on a predefined set of device capabilities of the communication devices; and in response to a transfer condition, designating a first-ranked communication device in the ordered list as the current group owner.

### CROSS-REFERENCE TO RELATED APPLICATIONS

This application claims priority to U.S. 63/724,473, filed Nov. 25, 2024 entitled “Method for Managing Dynamic Group Owner in a WiFi Direct System”, the contents of which are incorporated herein by reference in its entirety.

### BACKGROUND

Communication devices may communicate directly with one another via a peer-to-peer group communication session, rather than through a wireless area network. When a group communication session is established, one of the devices may be designated as the group owner to facilitate communications within the group. However, as the communication devices may be mobile or battery powered, the group owner may leave the group, resulting in dissolution of the group and increasing the time and efficiency for the remaining group members to communicate with one another.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for managing peer-to-peer group communications.

FIG. 2 is a block diagram of certain internal hardware components of one of the communication device of FIG. 1.

FIG. 3 is a flowchart of a method for managing peer-to-peer group communications.

FIG. 4 is a flowchart of a method for managing peer-to-peer group communications as the current group owner.

FIG. 5 is a flowchart of a method for managing peer-to-peer group communications as a member device.

FIG. 6 is a schematic diagram of maintaining an ordered list by the current group owner.

FIGS. 7A and 7B are schematic diagrams of managing the peer-to-peer group communications when a new device joins the group.

FIGS. 8A and 8B are schematic diagrams of managing the peer-to-peer group communications when a device leaves the group.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a group of communication devices communicating via a peer-to-peer group communication session, the method comprising: designating an initial communication device in the group as a current group owner; maintaining an ordered list of the communication devices in the group based on a predefined set of device capabilities of the communication devices; and in response to a transfer condition, designating a first-ranked communication device in the ordered list as the current group owner.

Additional examples disclosed herein are directed to a communication device comprising: a communications interface configured for communicating via a peer-to-peer group communication session; a processor interconnected with the communication interface, the processor configured to: maintain, as a current group owner of a group of communication devices in the group communication session, an ordered list of the communication devices in the group based on a predefined set of device capabilities of the communication devices; and broadcast the ordered list to the group of communication devices, such that, in response to a transfer condition, a first-ranked communication device in the ordered list is designated as the current group owner.

Additional examples disclosed herein are directed to a communication device comprising: a communications interface configured for communicating via a peer-to-peer group communication session; a processor interconnected with the communication interface, the processor configured to: receive a beacon from a current group owner of a group of communication devices in the group communication session, the beacon including an ordered list determined by the current group owner; store the ordered list locally; and in response to detecting a transfer condition, identify a first-ranked communication device in the ordered list as the current group owner.

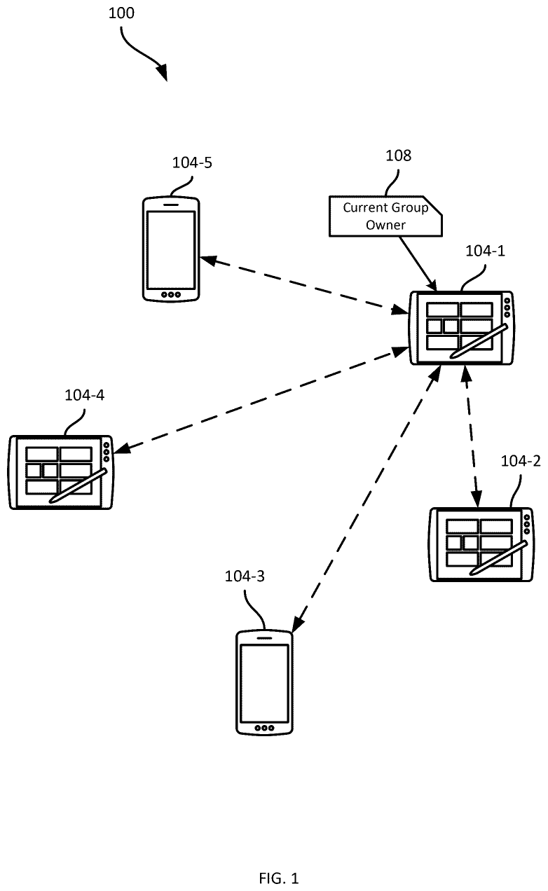

FIG. 1 depicts a communication system including a group 100 of communication devices 104 communicating via a peer-to-peer group communication session in accordance with the teachings of this disclosure. In the present example, five communication devices 104-1, 104-2, 104-3, 104-4, and 104-5 (referred to herein generically as a device 104 and collectively as the devices 104; this nomenclature may also be used elsewhere herein) are depicted in the group 100; in other examples, more or fewer devices 104 may be part of the group 100.

The group 100 may be established to manage large groups of customers, such as in drive-through lines, lines for outdoor activities, patrons of events and/or venues, and the like. In particular, the group 100 of devices 104 may be employed to obtain patron or customer information (e.g., obtain orders, check in with the event or scan tickets and the like) and to exchange information with one another in substantially real time to manage the customer group.

In such environments a robust wide-area network which can be readily accessed by all the devices 104 in a group may be difficult to establish, and further, in some examples, the devices 104 employed in such facilities and environments may be enabled with WiFi capabilities only, without WAN capabilities, for example for cost and device-management reasons. Accordingly, the group 100 may establish a peer-to-peer group communication session to allow direct or peer-to-peer communications (e.g., via WiFi Direct™) rather than communicating through a centralized access point. For example, the devices 104 in the group 100 may communicate via Bluetooth or Bluetooth Low Energy (BLE) or other suitable short-range wireless communications protocol. In other examples, the devices 104 in the group 100 may communicate via WiFi peer-to-peer technologies such as WiFi Direct™ or other suitable wireless peer-to-peer communications protocol.

To facilitate moderation of the group 100, one of the devices 104 may be designated as the group owner 108. Currently, the role of the group owner 108 is designated to the device 104 which initiates establishment of the group 100. Once the group 100 is established, other client devices 104 may connect with the group owner 108 to begin communications.

However, in some scenarios, the device 104 designated as the group owner 108 may be disconnected from the group 100, for example by moving out of range, switching off or limiting functionality due to battery concerns, or the like. In such instances, the group 100 also dissolves and the remaining devices 104 may start a new group with a new group owner 108 to continue communication. However, this process is time-consuming as a full exchange of credentials and formation of the group must be performed again. Additionally, such a method is prone to missing members of the original group when establishing the new group, resulting in multiple sub-groups.

Thus, in accordance with the present disclosure, the group owner 108 of the group 100 may be a dynamic designation, allowing the group 100 to be maintained after the device 104 which is designated as the group owner 108 leaves the group 100, without dissolving and re-establishing an alternate version of the group 100. That is, the group owner 108 is a dynamic role, in which multiple or all of the devices 104 in the group are capable of acting as the group owner 108 in prescribed conditions as described herein.

In particular, during the initial formation of the group 100, an initial device, such as the device 104-1 may be designated as the current group owner 108, for example according to a standard protocol, such as the device 104-1 initiating formation of the group 100. The current group owner 108 obtains device capabilities of each of the other devices 104 in the group 100 and defines an ordered list based on the device capabilities. In particular, the ordered list may be defined according to a set of rules by which to evaluate the device capabilities. The ordered list defines a priority order in which the remaining devices 104 may dynamically take over the role of the group owner 108 should the current group owner 108 leave the group or should the group 100 otherwise encounter a transfer situation for the group owner 108. Thus, the rules for establishing the ordered list may be defined according to device capabilities which support the group ownership functionality of the devices. For example, certain device capabilities may designate a device 104 as being a “master” group owner, such as a statically located or powered device, which may be unlikely to leave the group 100, and hence may provide more consistency for the group. In groups 100 in which no device 104 has a master group owner designation, the ordered list facilitates the dynamic transfer of group ownership to allow the group to be maintained through various transfer conditions.

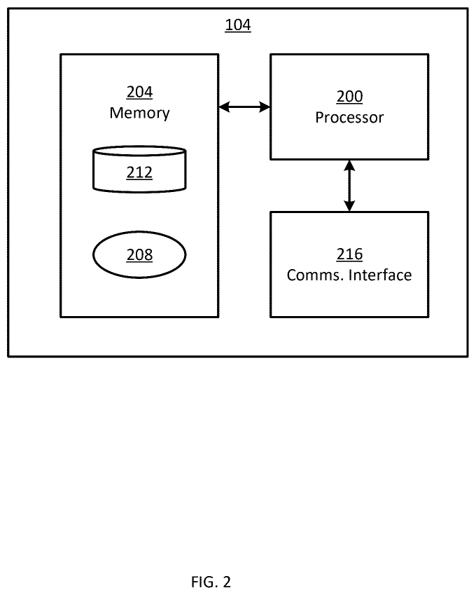

Referring to FIG. 2, a block diagram of certain internal components of an example one of the devices 104 is depicted.

The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits.

The memory 204 stores computer-readable instructions for execution by the processor 200, including one or more applications which, when executed, configure the processor 200 to perform the various functions of the device 104. In particular, the memory 204 may store an application 208 for operating within a group communication session, including the functionality to dynamically operate as a group owner, as described herein. The memory 204 may further store a repository 212 for storing an ordered list of the devices the group to allow for dynamic selection of the group owner as described herein.

The device 104 further includes a communications interface 216 enabling the device 104 to exchange data with other computing devices, such as the other devices 104. The communications interface 216 is interconnected with the processor 200. The communications interface 216 may include a controller, and one or more antennas, transmitters, receivers, or the like (not shown), to allow the device 104 to communicate with other computing devices such as other devices 104, for example via a WiFi Direct™ protocol, or other suitable peer-to-peer communications protocols. The communications interface 216 may further allow the device 104 to communicate with (e.g., to broadcast signals, via a two-way communication link, etc.) other computing devices according to other communications protocols, such as a BLE protocol or other suitable wireless transmission protocol.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

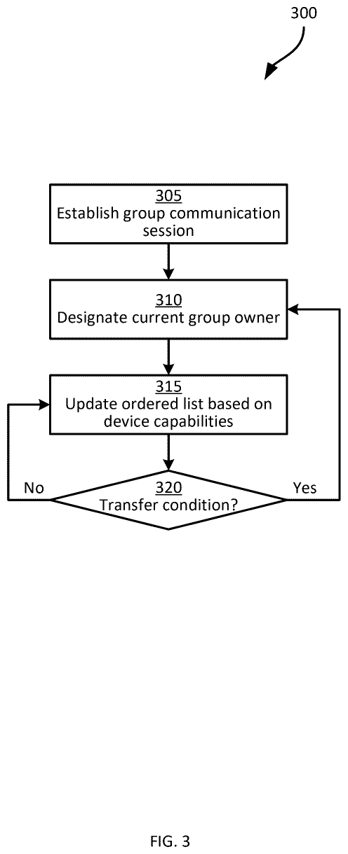

Turning now to FIG. 3, the functionality implemented by one of the devices 104 will be discussed in greater detail. FIG. 3 illustrates a method 300 for managing a group communications session with a dynamic group owner. The method 300 will be discussed in conjunction with its performance in the group 100. In other examples, the method 300 may be performed by other suitable devices or systems.

At block 305, the group 100 is formed and a peer-to-peer group communication session is established between the devices 104 of the group 100. The group 100 may be formed according to standard protocols according to the communication protocol utilized to support the group session.

At block 310, a designation of the current group owner 108 is assigned. During an initial iteration of the method 300, the current group owner 108 may be assigned to the device 104 which initiated the formation of the group 100.

At block 315, as part of the group formation and designation of the initial current group owner 108, the devices 104 may exchange device capabilities. The device capabilities may include parameters such as an intent value (i.e., a predefined willingness of a device to act as a group owner of a group), WAN capability, WiFi hardware generation indicator, capability and/or connectivity to additional services (e.g., display, printers, etc.), battery information (e.g., as a percentage, a number of hours, a binary or other step-wise threshold value, or the like), and the like.

The device 104 acting as the current group owner 108 may assess the device capabilities of each of the devices 104 in the group 100 according to predefined rules to assess the device capabilities. For example, each device capability or parameter may be assigned a score (e.g., based on a step-wise function or a predefined assignment of a score to each categorization or the like), and scores for each capability may be summed to determine an overall score for each device 104. In some examples, the overall score may be determined via a weighted summation with different weights assigned to each capability. The ordered list may include the device capability parameters to facilitate assessment of a subsequent group owner as described herein, or the ordered list may simply identify the devices 104.

The current group owner 108 may then define an ordered list of the devices 104 in the group 100 according to the set of device capabilities of the communication devices 104. That is, the current group owner 108 uses the set of capabilities to assess the device 104 which would be best suited for next taking over as the group owner 108 and prioritizes the devices 104 accordingly in the ordered list. In other examples, other suitable manners and set of capabilities for defining the ordered list are contemplated.

In some examples, the ordered list may include the device 104 acting as the current group owner 108, for example in a specifically designated position in the ordered list (e.g., a zero-eth spot or the like), as a separately designated addendum to the ordered list or the like. In other examples, the ordered list may be restricted to non-current group owner devices 104 of the group 100.

After defining the ordered list, the current group owner 108 may propagate the ordered list to each of the member devices 104 in the group 100. For example, the current group owner 108 may be configured to periodically issue a beacon to the group 100 including information allowing the member devices 104 to communicate in the group communication session. The ordered list may be included in such a beacon issued by the current group owner 108. The member devices 104 may be configured to extract the ordered list from the beacon received from the current group owner 108 and store the ordered list locally.

As devices 104 are added to the group 100, the current group owner 108 may iteratively obtain the device capabilities of the predefined set of capabilities of the new device 104 and may update the ordered list to include the new device 104. The current group owner 108 may propagate the updated ordered list including the new device 104. Similarly, as devices 104 are removed from the group 100, the current group owner 108 may update the ordered list to exclude the device 104 which left the group and propagate the updated ordered list.

That is, the current group owner 108 is responsible for maintaining and updating the ordered list, while the remaining devices 104 in the group 100 monitors or listens for updates to the ordered list from the current group owner 108 to ensure each member of the group 100 has the same ordered list.

In some examples, adding and removing devices 104 from the group 100 may result in a transfer condition, in which the designation of the current group owner 108 is to be transferred from one device 104 to a different device 104. For example, if a new device 104 joins the group 100 which has superior capabilities than the current group owner 108 (e.g., the device 104 is designated as being a master group owner due to being statically located or powered device), the designation of the current group owner 108 may be transferred to the new device 104. Similarly, if the current group owner 108 leaves the group 100, then the designation of the current group owner 108 may be transferred to a device 104 remaining in the group 100.

Accordingly, at block 320, if no transfer condition is detected, the method 300 returns to block 315, where the current group owner 108 continues to maintain and update the ordered list and propagate the ordered list to other member devices 104 of the group 100.

If, at block 320, a transfer condition is detected, then the method 300 returns to block 310 to designate a different device 104 as the current group owner 108. In particular, on subsequent iterations of block 310, the current group owner 108 may be designated based on the ordered list. Since each device 104 has a copy of the ordered list as distributed by the current group owner 108, upon detecting the transfer condition, each of the devices 104 may use the ordered list to identify or designate the same device 104 as the new current group owner 108. Specifically, the first-ranked device 104 on the ordered list may be assigned the designation of the current group owner 108.

Accordingly, upon detecting the transfer condition, the first-ranked device 104 on the ordered list may then take over maintaining, updating and propagating the ordered list. Similarly, the remaining devices 104 may listen or monitor for beacons issued by the first-ranked device 104 as the new current group over.

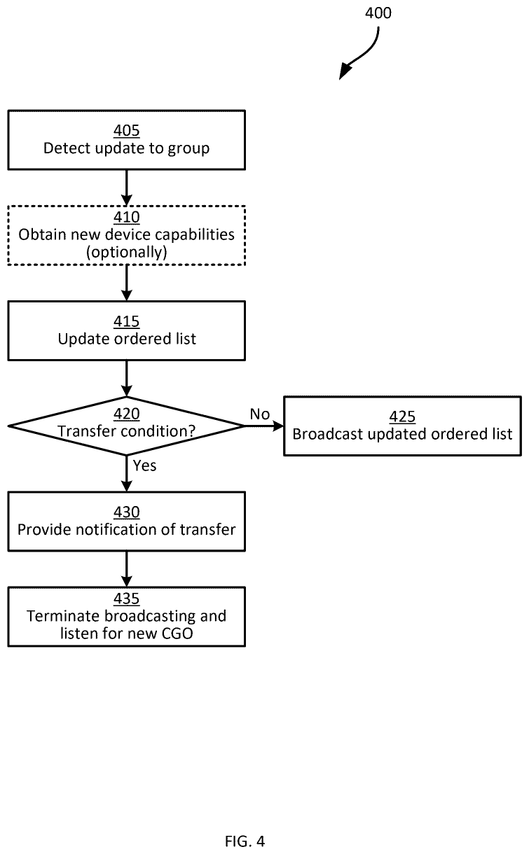

Referring to FIG. 4, an example method 400 of managing a group communications session by the current group owner is depicted. That is, the method 400 illustrates the actions specifically performed by the device 104 acting as the current group owner 108, for example during a performance of the method 300. The method 400 will be described in conjunction with its performance by the device 104-1 acting as the current group owner 108; in other examples, the method 400 may be performed by other devices.

At block 405, the device 104-1, acting as the current group owner 108, detects an update to the group 100. The update to the group may be, for example, a new device 104 joining the group 100, or a current member device 104 leaving the group 100.

If the update to the group 100 is an addition of a new device 104 to the group 100, then the device 104-1 proceeds to block 410. At block 410, the device 104-1 obtains the device capabilities from the new device 104. The device capabilities may include the same parameters in the predefined set of device capabilities as exchanged during the formation of the group 100. For example, these may include the intent value, the WAN capability, the WiFi hardware generation, any capability and/or connectivity to additional services, battery information, and the like. The device 104-1 may then proceed to block 415.

If the update to the group 100 is the removal of a current device 104 from the group 100, then the device 104-1 may skip block 410 and proceed directly to block 415.

At block 415, the device 104-1 is configured to update the ordered list based on the update to the group 100. In particular, if a new device 104 is added to the group 100, then the device 104-1 may use the set of capabilities obtained from the new device 104 at block 410 to assess the suitability of the new device 104 to act as the current group owner 108 and rank or prioritize the new device 104 relative to the existing member devices 104 in the ordered list. If a current member device 104 is removed from the group 100, then the device 104-1 may simply remove the departed device 104 from the ordered list. In other examples, the device 104-1 may re-assess the suitability of the remaining devices 104 in the group based on the set of capabilities and regenerate the ordered list.

At block 420, the device 104-1 is configured to determine if a transfer condition has occurred. In particular, a transfer condition may occur when a newly added device 104 has device capabilities superseding the device 104-1 acting as the current group owner 108. For example, a device 104 having a master group owner designation (e.g., as indicated by an intent value above a certain threshold or having a specific predefined value) may join the group 100. If the device 104-1 is mobile and may potentially leave the group 100 (e.g., based on reduced battery power, connectivity, etc.), then the device 104-1 may determine that a transfer condition has occurred to cede responsibility of the designation of current group owner 108 to the new device 104. In other examples, the battery or other device capability parameters of the device 104-1 may have deteriorated sufficiently that another member device 104 is better suited for the designation of current group owner 108.

If the determination at block 420 is negative, that is, no transfer condition is detected and the device 104-1 is to maintain the designation as the current group owner 108, then the device 104-1 proceeds to block 425. At block 425, the device 104-1 broadcasts the ordered list reflecting the update to the group as detected at block 405, and correspondingly, to the ordered list as determined at block 415. The device 104-1 may continue to periodically broadcast the ordered list with the regular or periodic beacons to maintain the group communication session.

If the determination at block 420 is affirmative, that is, a transfer condition is detected, then the device 104-1 proceeds to block 430. At block 430, the current group owner may provide a notification of the transfer condition to the group 100.

In some examples, the notification may be an explicit notification that the designation of current group owner 108 is being transferred to the new device 104. The notification may be sent to both the new device 104 to prompt the new device 104 to take over responsibility of the current group owner 108, as well as to the member devices 104 to listen for subsequent beacons from the new device 104 as the current group owner 108.

In other examples, the notification may be implicit. For example, the device 104-1 may issue a final beacon at the designated time including the updated ordered list. The issuance of the updated ordered list may serve as an implicit notification of the transfer condition to the remaining devices 104 in the group. For example, the devices 104 may detect that the addendum and/or zero-eth designation of the current group owner 108 has transferred to a different device, namely the new device 104 added to the group.

At block 435, the device 104-1 terminates the functionality of broadcasting beacons to the group 100. That is, the device 104-1 may cease to function as the current group owner 108. The device 104-1 may return to functionality as a member device 104 and may listen for a beacon broadcast by the new current group owner 108 according to the priority in the updated ordered list.

In some examples, the termination of broadcasting beacons by the device 104-1 may effectively serve as the implicit notification at block 430. Thus, the device 104-1 may broadcast a final beacon with an ordered list, including the new device 104 which is to supersede the device 104-1 as the new current group owner 108 listed in a first-ranked or highest priority position in the ordered list. Upon detection by the other member devices 104 that no beacon is detected from the device 104-1, the member devices 104 may consult the ordered list and identify the new device 104 as the new designated current group owner 108.

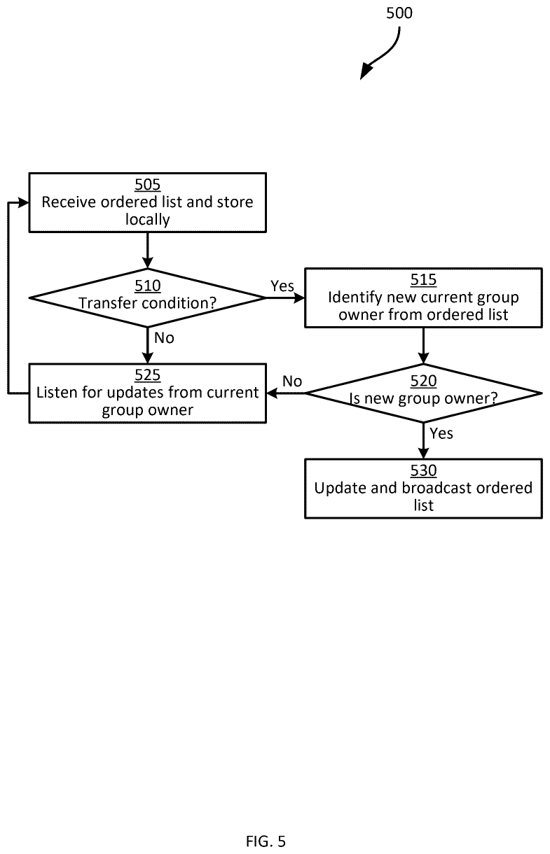

Referring to FIG. 5, an example method 500 of participating in a group communications session by a non-group owner member device is depicted. That is, the method 500 illustrates the actions performed by devices 104 of the group 100 which are not acting as the current group owner 108, for example during a performance of the method 300. The method 500 will be described with the device 104-1 acting as the current group owner 108; in other examples other devices may act as the current group owner 108.

At block 505, the member device 104 receives a copy of the ordered list and stores the ordered list locally. The ordered list may be received as part of a beacon broadcast by the device 104-1 acting as the current group owner 108.

At block 510, the member device 104 determines whether a transfer condition is detected. That is, the member device 104 may assess whether the device 104-1 is still the current group owner 108.

In some examples, the member device 104 may detect a transfer condition in response to a notification of a transfer. For example, the member device 104 may receive an explicit notification from the device 104-1, for example that a newly added device 104 is assuming responsibility of the designation of the current group owner 108. In other examples, the notification may be implicit, such as being included in the updated ordered list received at block 505. That is, the member device 104 may analyze the ordered list to determine whether the ordered list provides an indication that the designation of the current group owner 108 has been transferred (e.g., as indicated by a position on the ordered list, or by an addendum to the ordered list or the like.

In other examples, the member device 104 may detect a transfer condition based on the lack of beacon detected from the device 104-1 at the designated or expected interval. For example, when the device 104-1 leaves the group 100 unexpectedly, for example due to losing connectivity or battery or the like, then the member devices 104 may not receive the periodic beacons. After detecting a threshold amount of time or a threshold number of missed beacons, the member device 104 may determine that the device 104-1 has left the group 100 and/or that a transfer condition has occurred and make an affirmative determination at block 510.

If the determination at block 510 is negative, then the member device 104 proceeds to block 525 to continue to listen for updates from the device 104-1 acting as the current group owner 108.

If the determination at block 510 is affirmative, then the member device 104 proceeds to block 515. At block 515, the member device 104 is configured to identify a new current group owner 108 based on the ordered list received and stored locally at block 505. In particular, the member device 104 may select the first-ranked device on the ordered list (i.e., the device 104 having the highest priority). In some examples, where the ordered list includes the current group owner 108, the member device 104 may identify as the new current group owner 108, the first-ranked device on the ordered list which is not the device 104-1 (i.e., acting as the current group owner 108).

### At Block 520, the Member Device 104 Determines Whether it Itself Is the new current group owner 108.

If the determination at block 525 is negative, that is, the member device 104 itself is not the new current group owner 108, then the member device 104 proceeds to block 525. At block 525, the member device 104 listens for a beacon, including an updated ordered list, from the current group owner 108, as identified at block 515.

If the determination at block 525 is affirmative, that is, the member device 104 is the new current group owner 108, then the member device 104 proceeds to block 530. At block 530, the member device 104 takes over responsibilities as the current group owner 108, including broadcasting periodic beacons, maintaining and updating the ordered list and propagating the ordered list to other devices 104 in the group.

For example, the member device 104 may determine whether the device 104-1 previously acting as the current group owner has left the group, and hence may update the ordered list to remove the device 104.

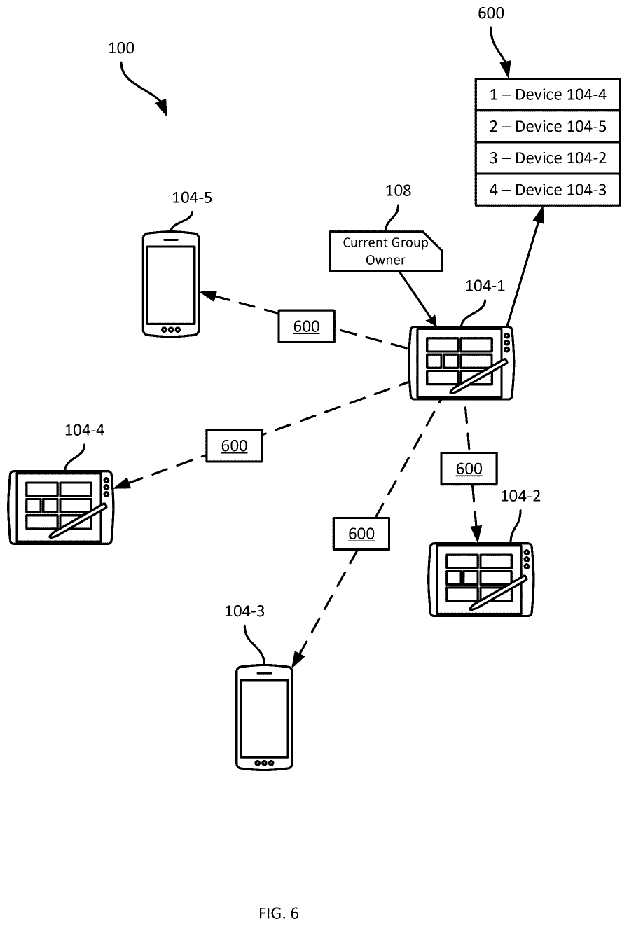

FIG. 6 depicts a schematic diagram of a performance of the method 300 in the group 100. In this example, the device 104-1 is designated as the current group owner 108. Accordingly, the device 104-1 may obtain the predefined set of device capabilities from each of the other member devices 104 of the group 100, namely, the devices 104-2, 104-3, 104-4, and 104-5. The device 104-1 may then analyze the device capabilities of each of the other member devices 104 and prioritize or rank them to create an ordered list 600. The ordered list 600 represents the priority in which the remaining member devices 104 are to take over the designation as the current group owner 108 in the event the device 104-1 leaves the group 100 or is otherwise incapable of continuing to act as the current group owner 108. The device 104-1 may then propagate the ordered list 600 to each of the remaining member devices 104, for example as a part of a periodic beacon issued by the device 104-1 acting in its capacity as the current group owner 108. The devices 104 may store a copy of the ordered list 600 locally.

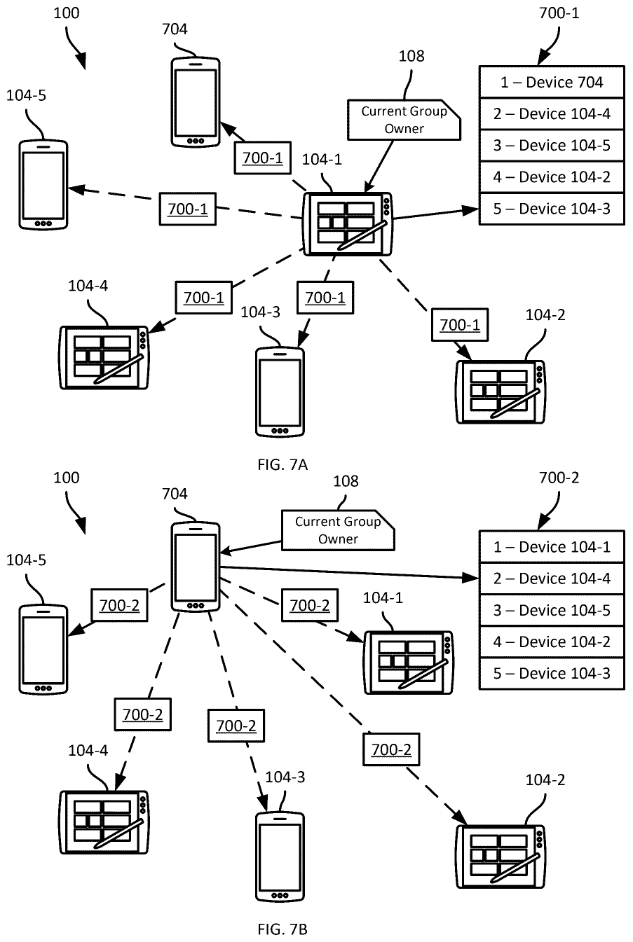

FIGS. 7A and 7B depict schematic diagrams of the operation of the group communication session in the group 100 when a new device 704 is added to the group 100.

In FIG. 7A, upon detecting that the new device 704 has joined the group 100, the device 104-1 acting as the current group owner 108 may obtain the predefined set of device capabilities from the device 704 and may update the ordered list 600 to generate an updated ordered list 700-1 including the new device 704. In the present example, the new device 704 may be ranked in a higher priority order than the other member devices 104. In other examples, the new device 704 may be otherwise ranked in the ordered list 700-1 according to its relative device capabilities. The device 104-1 then propagates the updated ordered list 700-1 to each of the member devices 104 and the newly added device 704, for example as a part of the periodic beacon issued by the device 104-1 acting in its capacity as the current group owner 108. The devices 104 may store a copy of the updated ordered list 700-1 locally. If no transfer condition is detected, the device 104 may continue to act as the current group owner 108 and broadcast beacons.

In FIG. 7B, if a transfer condition is detected, such as if the device 704 actually supersedes the capabilities of the device 104-1, then the device 104-1 may transfer the designation of the current group owner 108 to the new device 704. Accordingly, the device 104-1 may terminate broadcasting the periodic beacons and the ordered lists. The device 704, having detected a lack of periodic beacons from the device 104-1 acting as the current group owner 108 may consult the ordered list 700-1 and identify that the device 704 itself, as the first-ranked device in the ordered list 700-1, is to assume responsibility as the current group owner 108. In other examples, the device 704 may make this determination based on a notification from the device 104-1. Similarly, the remaining member devices 104, having detected the lack of periodic beacons from the device 104-1 may consult the locally stored ordered list 700-1 and identify that the device 704, as the first-ranked device in the ordered list 700-1, is to assume responsibility as the current group owner 108. Accordingly, the devices 104 may listen for beacons from the device 704.

The device 704, in assuming responsibility as the current group owner 108 may take over maintenance of the ordered list. In particular, the device 704 may further update the ordered list 700-1 to an ordered list 700-2 excluding itself and including the device 104-1 which is no longer acting as the current group owner 108. In the present example, the device 104-1 may be first-ranked in the ordered list 700-2; in other examples, the device 104-1 may be otherwise ranked based on its device capabilities. The device 704 may then propagate the updated ordered list 700-2 to each of the member devices 104, for example as a part of a periodic beacon issued by the device 704 acting in its new capacity as the current group owner 108. The devices 104 may store a copy of the updated ordered list 700-2 locally.

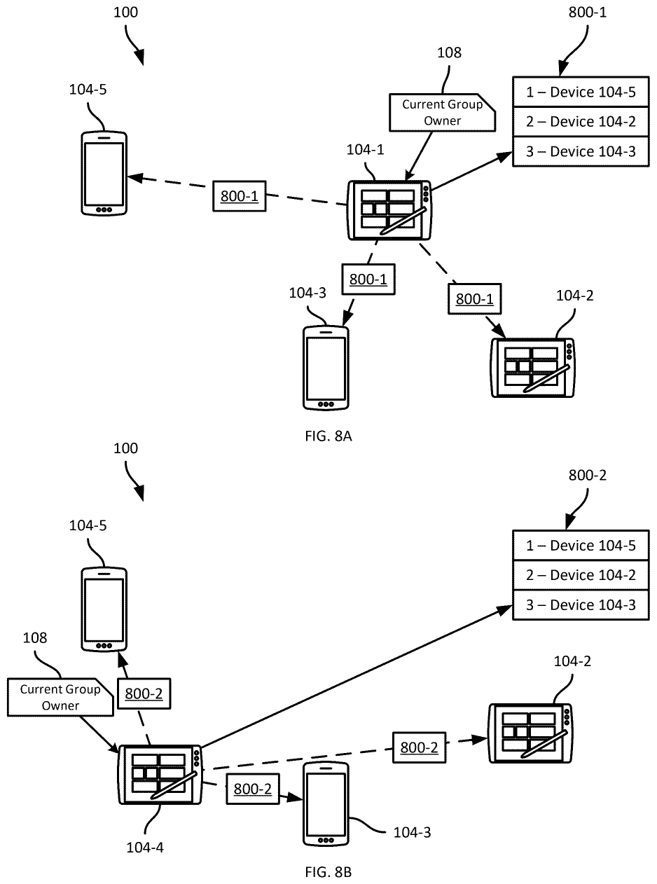

FIGS. 8A and 8B depict schematic diagrams of the operation of the group communication session in the group 100 when one of the devices 104 leaves the group 100.

In FIG. 8A, the departing device is the device 104-4, which is not designated as the current group owner 108. Upon detecting that the device 104-4 has left the group 100, the device 104-1 acting as the current group owner 108 updates the ordered list 600 to generate an updated ordered list 800-1 excluding the departed device 104-4. The remaining devices on the ordered list 800-1 may be re-prioritized accordingly and the device 104-1 propagates the updated ordered list 800-1 to each of the remaining member devices 104, for example as part of the periodic beacon issued by the device 104-1 acting in its capacity as the current group owner 108. The devices 104 may store a copy of the updated ordered list 800-1 locally.

In FIG. 8B, the departing device is the device 104-1, which has the designation of the current group owner 108. Upon the departure of the device 104-1, the group 100 has no current group owner 108. The remaining devices 104 may detect that the device 104-1 has left, for example in response to detecting a lack of the periodic beacons to be sent by the current group owner 108. Accordingly, each of the devices 104 may reference the ordered list 600 to determine that the first-ranked device in the ordered list 600 is the device 104-4. The device 104-4 may then assume responsibility as the current group owner 108 and take over maintenance of the ordered list. In particular, the device 104-4 may update the ordered list 600 to an ordered list 800-2 to exclude both itself and the departed device 104-1. The device 104-4 may then propagate the updated ordered list 800-2 to each of the remaining member devices 104, for example as part of the periodic beacon issued by the device 104-4 acting in its new capacity as the current group owner 108. The devices 104 may store a copy of the updated ordered list 800-2 locally.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a group of communication devices communicating via a peer-to-peer group communication session, the method comprising:
designating an initial communication device in the group as a current group owner;
maintaining an ordered list of the communication devices in the group based on a predefined set of device capabilities of the communication devices; and
in response to a transfer condition, designating a first-ranked communication device in the ordered list as the current group owner.

2. The method of claim 1, wherein maintaining the ordered list comprises:
obtaining, by the current group owner, the device capabilities of the communication devices in the group;
ordering the communication devices in the ordered list according to the device capabilities; and
broadcasting, by the current group owner, the ordered list to the group of communication devices.

3. The method of claim 1, wherein maintaining the ordered list comprises:
detecting, at one of the communication devices, a beacon from the current group owner, the beacon including the ordered list determined by the current group owner; and
storing the ordered list locally at the one of the communication devices.

4. The method of claim 1, wherein the predefined set of device capabilities includes one or more of:
an intent value;
a wide area network capability;
a hardware generation indicator;
additional service capability; and
battery information.

5. The method of claim 1, wherein the transfer condition comprises the current group owner leaving the group.

6. The method of claim 1, further comprising:
updating, by the first-ranked communication device as the current group owner, the ordered list; and
broadcasting the updated ordered list to the group.

7. The method of claim 1, further comprising:
identifying, by each remaining communication device in the group, the first-ranked communication device as the current group owner; and
monitoring for beacons by the first-ranked communication device as the current group owner.

8. The method of claim 1, wherein the transfer condition comprises a new device joining the group, the new device having higher ranking device capabilities than the current group owner.

9. The method of claim 8, further comprising, in response to detecting, by the current group owner, the new device having higher ranking device capabilities than the current group owner:
updating the ordered list to include the new device as the first-ranked communication device in the ordered list;
broadcasting the updated ordered list; and
terminating broadcasting periodic beacons as the current group owner.

10. The method of claim 9, further comprising notifying, by the current group owner, the group of communication devices of the transfer of a designation of the current group owner to the new device.

11. A communication device comprising:
a communications interface configured for communicating via a peer-to-peer group communication session;
a processor interconnected with the communication interface, the processor configured to:
maintain, as a current group owner of a group of communication devices in the group communication session, an ordered list of the communication devices in the group based on a predefined set of device capabilities of the communication devices; and
broadcast the ordered list to the group of communication devices, such that, in response to a transfer condition, a first-ranked communication device in the ordered list is designated as the current group owner.

12. The communication device of claim 11, wherein to maintain the ordered list, the processor is configured to:
obtain the device capabilities of the communication devices in the group; and
order the communication devices in the ordered list according to the device capabilities.

13. The communication device of claim 11, wherein the predefined set of device capabilities includes one or more of:
an intent value;
a wide area network capability;
a hardware generation indicator;
additional service capability; and
battery information.

14. The communication device of claim 11, wherein the transfer condition comprises a new device joining the group, the new device having higher ranking device capabilities than the current group owner.

15. The communication device of claim 14, wherein in response to detecting the new device having higher ranking device capabilities than the current group owner, the processor is configured to:
update the ordered list to include the new device as the first-ranked communication device in the ordered list;
broadcast the updated ordered list; and
terminate broadcasting periodic beacons as the current group owner.

16. The communication device of claim 15, wherein the processor is further configured to notify the group of communication devices of the transfer of a designation of the current group owner to the new device.

17. A communication device comprising:
a communications interface configured for communicating via a peer-to-peer group communication session;
a processor interconnected with the communication interface, the processor configured to:
receive a beacon from a current group owner of a group of communication devices in the group communication session, the beacon including an ordered list determined by the current group owner;
store the ordered list locally; and
in response to detecting a transfer condition, identify a first-ranked communication device in the ordered list as the current group owner.

18. The communication device of claim 17, wherein to detect the transfer condition, the processor is configured to:
detect a threshold number or a threshold period of missing beacons from the current group owner; and
in response, determine that the transfer condition has occurred.

19. The communication device of claim 17, wherein the processor is configured to, when the communication device is the first-ranked communication device in the ordered list:
update the ordered list; and
broadcast, as the current group owner, the updated ordered list to the group.

20. The communication device of claim 17, wherein the processor is configured to, when the communication device is not the first-ranked communication device in the ordered list:
identify the first-ranked communication device as the current group owner; and
monitor for beacons by the first-ranked communication device as the current group owner.
